(19) United States
(12) Patent Application Publication
(10) Pub. No.: US 2025/0293508 A1
(43) Pub. Date: Sep. 18, 2025

(54) SEMICONDUCTOR APPARATUS AND CONTROL SYSTEM

(71) Applicant: DENSO CORPORATION, Kariya-city (JP)

(72) Inventor: Hirokazu SADAMATSU, Kariya-city (JP)

(21) Appl. No.: 19/226,665

(22) Filed: Jun. 3, 2025

Related U.S. Application Data
(63) Continuation of application No. PCT/JP2023/041083, filed on Nov. 15, 2023.

(30) Foreign Application Priority Data
Dec. 6, 2022 (JP) 2022-194883

(51) Int. Cl. H02H 7/122; B62D 5/04; H02H 1/00

(52) U.S. Cl. CPC H02H 7/122; H02H 1/0007; B62D 5/0457

(57) ABSTRACT

A control system drives an inverter drive element in accordance with a command received by a semiconductor device main body from a microcomputer. The control system includes a semiconductor apparatus having: a drive circuit that drives the inverter drive element in accordance with the command received from the microcomputer; an anomaly determination unit that determines an anomaly of an overcurrent flowing through the inverter drive element; and a stop unit that stops driving the inverter drive element by the drive circuit regardless of the command from the microcomputer when the anomaly determination unit determines that the anomaly of the overcurrent occurs.

### CROSS REFERENCE TO RELATED APPLICATION

The present application is a continuation application of International Patent Application No. PCT/JP2023/041083 filed on Nov. 15, 2023, which designated the U.S. and claims the benefit of priority from Japanese Patent Application No. 2022-194883 filed on Dec. 6, 2022. The entire disclosures of all of the above applications are incorporated herein by reference.

### TECHNICAL FIELD

The present disclosure relates to a semiconductor apparatus and a control system using the semiconductor apparatus.

### BACKGROUND

Conventionally, a vehicle drive device that drives an inverter has been proposed according to a conceivable technique. This vehicle drive device is equipped with a voltmeter, a no-energization determiner that determines the no-energization state of the inverter, and an ammeter that detects the current applied to the motor from each phase arm of the inverter, and transmits these signals and a signal from the no-energization determiner to the motor control device. The motor control device determines whether an anomaly has occurred based on this signal and controls the drive of the inverter.

### SUMMARY

According to an example, a control system drives an inverter drive element in accordance with a command received by a semiconductor device main body from a microcomputer. The control system includes a semiconductor apparatus having: a drive circuit that drives the inverter drive element in accordance with the command received from the microcomputer; an anomaly determination unit that determines an anomaly of an overcurrent flowing through the inverter drive element; and a stop unit that stops driving the inverter drive element by the drive circuit regardless of the command from the microcomputer when the anomaly determination unit determines that the anomaly of the overcurrent occurs.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an electrical configuration diagram schematically showing a control system according to a first embodiment;

FIG. 2 is an explanatory diagram showing a schematic structure of an electric power steering system according to a first embodiment;

FIG. 3 is a flow chart that illustrates the flow of operations in the first embodiment;

FIG. 4 is a time chart showing the changes in the signals of each part from when an anomaly is detected to when the inverter drive element is stopped in the first embodiment;

FIG. 5 is an electrical configuration diagram showing a comparative example;

FIG. 6 is an electrical configuration diagram schematically showing a control system according to a second embodiment;

FIG. 7 is a time chart showing the changes in the signals of each part from when an anomaly is detected to when the inverter drive element is stopped in the second embodiment;

FIG. 8 is a first explanatory diagram showing a modification example of the timing for stopping the output of the drive signal from the microcomputer in the second embodiment;

FIG. 9 is a second explanatory diagram showing a modification example of the timing for stopping the output of the drive signal from the microcomputer in the second embodiment;

FIG. 10 is an electrical configuration diagram schematically showing a control system according to a third embodiment;

FIG. 11 is an electrical configuration diagram schematically showing a control system according to a fourth embodiment;

FIG. 12 is an electrical configuration diagram schematically showing a control system according to a fifth embodiment; and

FIG. 13 is an electrical configuration diagram schematically showing a control system according to a sixth embodiment.

### DETAILED DESCRIPTION

The applicant of the present application has previously proposed a control system similar to that described in the conceivable technique. The control system provided by the applicant of the present application includes a microcomputer, and the semiconductor device main body is configured separately from the microcomputer, and the semiconductor device main body drives the inverter drive element according to commands received from the microcomputer.

Conventionally, when an anomaly occurs due to an overcurrent, the semiconductor device main body detects the current and then notifies the anomaly to a microcomputer via communication. When the microcomputer receives the anomaly notification, the microcomputer outputs a drive signal for stopping driving to the inverter drive element through the semiconductor device main body.

In the control system described in the conceivable technique, a period of time may become long from when the semiconductor device main body detects an anomaly to when the drive of the inverter drive element is actually stopped. This increases the risk of the failure in the inverter drive element. To prevent such failures, it is necessary to increase the tolerance, but this requires increasing the size of the inverter drive element, which undesirably increases the mounting area.

An object of the present embodiments is to provide a semiconductor apparatus that can shorten the time from detection of an anomaly to stopping the driving of an inverter drive element, and a control system that uses this semiconductor apparatus.

According to an aspect of the present embodiments, a semiconductor apparatus that includes a microcomputer and a semiconductor device main body separate from the microcomputer, and that constitutes a control system in which the semiconductor device main body drives an inverter driving element in accordance with a command received from the microcomputer. The drive circuit drives the inverter drive element in accordance with a command received from the microcomputer. The anomaly determination unit determines whether an anomaly occurs in an overcurrent flowing through an inverter drive element. The stop unit stops driving by the drive circuit regardless of a command from the microcomputer when the anomaly determination unit determines that an anomaly occurs.

According to one aspect of the present embodiments, the stop unit stops driving by the drive circuit regardless of a command from the microcomputer. Therefore, if the anomaly determination unit determines that an anomaly of an overcurrent exists, the driving by the drive circuit can be immediately stopped regardless of whether or not there is a command from the microcomputer. As a result, the time from detection of an anomaly to stopping the driving of the inverter drive element can be shortened as much as possible.

Hereinafter, several embodiments of a semiconductor apparatus and a control system will be described with reference to the drawings. In the embodiments described below, the same or similar components among the embodiments are assigned the same or similar reference numerals, and description thereof may be omitted.

### First Embodiment

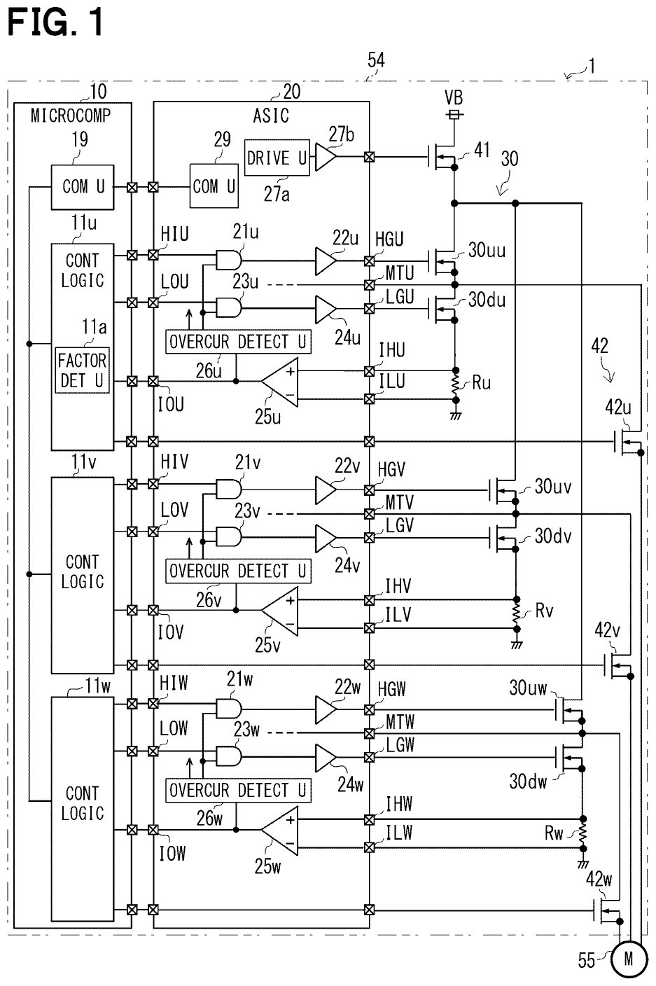

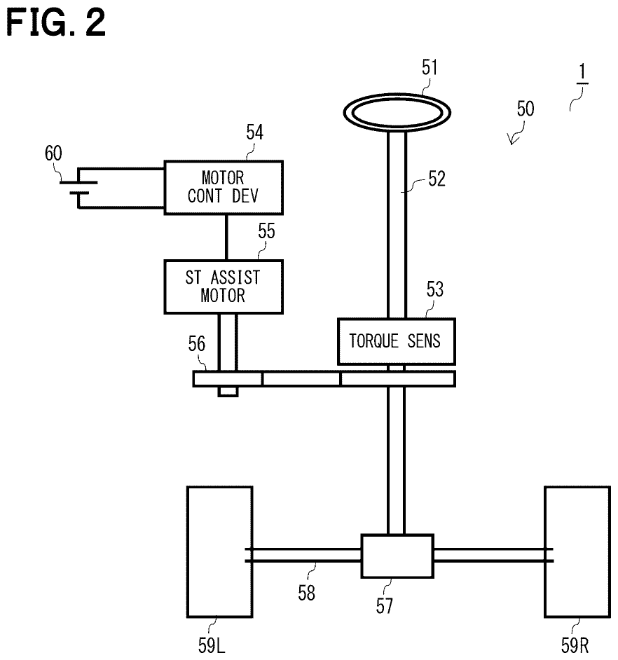

The following describes a first embodiment with reference to FIGS. 1 to 5. FIG. 2 illustrates an example of the entire control system 1. The control system 1 is configured with an electric power steering system 50. The electric power steering system 50 provides a steering assist torque to a steering shaft 52 for assisting the steering torque generated by the driver's operation of a steering wheel 51. FIG. 2 shows a schematic structure of a pinion-assist type electric power steering system 50.

The steering shaft 52 is coupled to the steering wheel 51. A torque sensor 53 for detecting the steering torque is provided on the steering shaft 52. The pinion gear 57 is provided at an end of the steering shaft 52 and engaged with the rack shaft 58.

A pair of wheels 59R, 59L are rotatably connected to both ends of the rack shaft 58 via tie rods or the like. A rotational movement of the steering shaft 52 is converted into a linear movement of the rack shaft 58 by the pinion gear 57 when the steering shaft 52 rotates. As a result, the pair of wheels 59R, 59L are steered to an angle corresponding to the displacement of the linear movement of the rack shaft 58.

The electric power steering system 50 includes a motor drive device 54, a steering assist motor 55, and a reduction gear 56. The motor drive device 54 is connected to a battery 60 serving as a DC power source, and drives the steering assist motor 55 using the electric power of the battery 60. The steering assist motor 55 in this embodiment is configured by a three-phase AC brushless motor. Hereinafter, the steering assist motor 55 will be abbreviated as “motor 55.” The motor 55 generates a steering assist torque. The reduction gear 56 decelerates the rotation of the motor 55 and transmits it to the steering shaft 52.

The electric power steering system 50 performs current control based on a steering torque signal detected by a torque sensor 53 to control the drive torque of a motor 55, thereby assisting the steering operation by the driver in accordance with the driving conditions. The electric power steering system 50 can be configured as a more fuel-efficient system than a hydraulic power steering system. This system is also called an EPS system. EPS is an abbreviation for Electric Power Steering.

As shown in FIG. 1, the motor drive device 54 includes a microcomputer 10, an ASIC 20, an inverter 30, a backflow prevention transistor 41, and a relay 42. The inverter 30 is a three-phase AC inverter that converts a power source voltage VB of a DC battery 60 into AC power and supplies it to the motor 55.

The inverter 30 is configured by connecting inverter drive elements, which are N-channel type high-side MOS transistors 30uu, 30uv, and 30uw and N-channel type low-side MOS transistors 30du, 30dv, and 30dw, in a bridge connection.

The shunt resistor Ru is connected in series to the high-side MOS transistor 30uu and the low-side MOS transistor 30du. The shunt resistor Rv is connected in series to the high-side MOS transistor 30uv and the low-side MOS transistor 30dv. The shunt resistor Rw is connected in series to the high-side MOS transistor 30uw and the low-side MOS transistor 30dw.

The backflow prevention transistor 41 is connected between the supply terminal of the power source voltage VB of the battery 60 and the inverter 30, and conducts the power source voltage VB in one direction to the inverter 30, thereby preventing the backflow to the battery 60. The relay transistors 42u, 42v, and 42w are each formed of an N-channel MOS transistor that conducts the power source voltage VB in one direction to the motor 55. In this embodiment, the shunt resistors Ru, Rv, and Rw are provided for each of the U-, V-, and W-phases, but the present embodiment is not limited to this feature. For example, the shunt resistors Ru, Rv, and Rw of the U-, V-, and W-phases may be integrated into one shunt resistor, and the current may be detected by the one shunt resistor. In this case, a backflow prevention transistor 41 may be connected to the current path from the integrated shunt resistor to the ground node.

The relay 42 includes relay transistors 42u, 42v, and 42w. The drain-source of the relay transistor 42u is connected between the motor 55 and the common connection point of the high-side MOS transistor 30uu and the low-side MOS transistor 30du. The drain-source of the relay transistor 42v is connected between the motor 55 and the common connection point of the high-side MOS transistor 30uv and the low-side MOS transistor 30dv.

The drain-source of the relay transistor 42w is connected between the motor 55 and the common connection point of the high-side MOS transistor 30uw and the low-side MOS transistor 30dw. The gates of these relay transistors 42u, 42v, 42w are connected to the microcomputer 10, and are controlled to be turned on and off by control logics 11u, 11v, 11w of the microcomputer 10, respectively.

### <Configuration of Microcomputer 10>

The microcomputer 10 is a microcontroller or microcomputer including control logics 11u, 11v, and 11w that are connected to each other, and a communication unit 19 that is connected to the control logics 11u, 11v, and 11w. The control logics 11u, 11v, and 11w are configured to be able to switch between enabling and disabling the energization from the inverter 30 to the motor 55 by controlling the gates of the relay transistors 42u, 42v, and 42w to be turned on or off.

The control logics 11u, 11v, and 11w output high-side drive signals via terminals HIU, HIV, and HIW of the ASIC 20, respectively. The control logics 11u, 11v, and 11w output low-side drive signals through terminals LOU, LOV, and LOW of the ASIC 20, respectively. The drive signal is a PWM-modulated pulse signal, and serves as a command from the microcomputer 10 to the ASIC 20.

The microcomputer 10 includes a functional block serving as a factor determination unit 11a. Although FIG. 1 illustrates an embodiment in which the factor determination unit 11a is configured in the control logic 11u, the present embodiment is not limited to this feature. When the factor determination unit 11a receives a notification of an anomaly detection from the communication unit 29 via the communication unit 19, the factor determination unit 11a determines the factor of the anomaly.

The factor determination unit 11a is a functional block that determines, based on a notification of anomaly detection from the ASIC 20, whether an anomaly caused by an overcurrent occurs in any of the U-, V- and W-phases as the factor of the anomaly, or whether any other anomaly occurs. The control logics 11u, 11v, and 11w output or stop outputting driving signals to the ASIC 20 based on the factor of the anomaly determined by the factor determination unit 11a.

The communication unit 19 is connected to a communication unit 29 of the ASIC 20. The communication unit 19 receives a notification of the anomaly detection from the communication unit 29 of the ASIC 20 when the overcurrent detection units 26u, 26v, and 26w of the ASIC 20 determine that an overcurrent anomaly occurs. The control logics 11u, 11v, and 11w are connected to a communication unit 19, and output or stop outputting a drive signal to the ASIC 20 based on whether or not an anomaly detection is received by the communication unit 19.

### <Description of the Configuration of ASIC 20>

The ASIC 20 includes gates 21u, 21v, 21w, 23u, 23v, and 23w, drive circuits 22u, 22v, 22w, 24u, 24v, and 24w, and current amplifiers 25u, 25v, and 25w. The ASIC 20 also includes overcurrent detection units 26u, 26v, and 26w, a drive unit 27a, a buffer 27b, and a communication unit 29. When an enable signal for permission of the driving is transmitted from the communication unit 19 of the microcomputer 10 to the communication unit 29, the drive unit 27a and the buffer 27b of the ASIC 20 turn on the backflow prevention transistor 41 to turn on the energization to the inverter 30.

The common connection point of the high-side MOS transistor 30uu and the low-side MOS transistor 30du is connected to the terminal MTU of the ASIC 20. The common connection point of the high-side MOS transistor 30uv and the low-side MOS transistor 30dv is connected to the terminal MTV of the ASIC 20. The common connection point of the high-side MOS transistor 30uw and the low-side MOS transistor 30dw is connected to the terminal MTW of the ASIC 20. The terminals MTU, MTV, and MTW are connected to voltage division resistors during an appropriate period and are capable of measuring the voltages, but are not shown in the drawings because they are not related to the features of the present embodiments.

The current amplifier 25u amplifies and detects the voltage between the terminals of the shunt resistor Ru, thereby detecting the current flowing through the high-side MOS transistor 30uu and the low-side MOS transistor 30du. The current amplifier 25u outputs a signal to the control logic 11u of the microcomputer 10 through a terminal IOU, and also to an overcurrent detection unit 26u.

The current amplifier 25v amplifies and detects the voltage between the terminals of the shunt resistor Rv, thereby detecting the current flowing through the high-side MOS transistor 30uv and the low-side MOS transistor 30dv. The current amplifier 25v outputs a signal to the control logic 11v of the microcomputer 10 through a terminal IOV, and also outputs a signal to an overcurrent detection unit 26v.

The current amplifier 25w amplifies and detects the voltage between the terminals of the shunt resistor Rw, thereby detecting the current flowing through the high-side MOS transistor 30uw and the low-side MOS transistor 30dw. The current amplifier 25w outputs a signal to the control logic 11w of the microcomputer 10 through a terminal IOW, and also outputs a signal to an overcurrent detection unit 26w.

The overcurrent detection units 26u, 26v, 26w are provided as an anomaly determination unit that receives the detection results of the current amplifiers 25u, 25v, 25w, detects whether an overcurrent is occurring, and determines whether an anomaly of the overcurrent occurs. The overcurrent detection units 26u, 26v, 26w includes a comparator that compares the detection results of the current amplifiers 25u, 25v, 25w with a first anomaly determination threshold Ita for anomaly determination, and a counter that counts the number of times the detection results reach the threshold Ita. When the count number reaches a predetermined number, the overcurrent detection units 26u, 26v, and 26w determine that an overcurrent anomaly has occurred.

Here, a feature will be described in which the first anomaly determination threshold values Ita for each of the U-, V- and W-phases are set to the same value, but the present embodiment is not limited to this feature. The first anomaly determination threshold values Ita for each of the U-, V-, and W-phases may be set to different values.

When the overcurrent detection units 26u, 26v, and 26w determine that an overcurrent anomaly has occurred, the overcurrent detection units 26u, 26v, and 26w notify the communication unit 29 and output a low level to the gates 21u, 21v, 21w, 23u, 23v, and 23w, respectively, indicating that an anomaly has been detected. The communication unit 29 is used as a notification unit that notifies the communication unit 19 of the microcomputer 10 that an overcurrent anomaly has been determined when any of the overcurrent detection units 26u, 26v, 26w has determined that an overcurrent anomaly has occurred.

Each of the gates 21u, 21v, 21w, 23u, 23v, and 23w is configured by an AND gate.

### <High Side Drive Explanation>

The gates 21u, 21v, and 21w respectively receive drive signals for the high-side MOS transistors 30uu, 30uv, and 30uw from the control logics 11u, 11v, and 11w, and also receive outputs from the overcurrent detection units 26u, 26v, and 26w.

The gates 21u, 21v, and 21w are configured as stopping units that stop the output of the drive signals input from the control logics 11u, 11v, and 11w when the overcurrent detection units 26u, 26v, and 26w respectively determine that an overcurrent anomaly occurs.

The gates 21u, 21v, and 21w receive the drive signals from the control logics 11u, 11v, and 11w, respectively. The gates 21u, 21v, and 21w output the input drive signals to the drive circuits 22u, 22v, and 22w, on the condition that the overcurrent detection units 26u, 26v, and 26w have not determined that an overcurrent anomaly occurs.

The drive circuits 22u, 22v, and 22w are configured with buffers that shape the waveforms of the outputs of the gates 21u, 21v, and 21w, and are connected to the gates of the high-side MOS transistors 30uu, 30uv, and 30uw, respectively. When the drive circuits 22u, 22v, and 22w receive the drive signals from the gates 21u, 21v, and 21w, the drive circuits 22u, 22v, and 22w output the drive signals to the gates of the high-side MOS transistors 30uu, 30uv, and 30uw.

### <Explanation of Low-Side Drive>

The gates 23u, 23v, and 23w respectively receive drive signals for the low-side MOS transistors 30du, 30dv, and 30dw from the control logics 11u, 11v, and 11w, and also receive outputs from the overcurrent detection units 26u, 26v, and 26w.

The gates 23u, 23v, and 23w are configured as stopping units that stop the output of the drive signals input from the control logics 11u, 11v, and 11w when the overcurrent detection units 26u, 26v, and 26w respectively determine that an overcurrent anomaly occurs.

The gates 23u, 23v, and 23w receive the drive signals from the control logics 11u, 11v, and 11w, respectively. The gates 23u, 23v, and 23w output the input drive signals to the drive circuits 24u, 24v, and 24w, on the condition that the overcurrent detection units 26u, 26v, and 26w have not determined that an overcurrent anomaly occurs.

The drive circuits 24u, 24v, 24w are also configured with buffers that shape the waveforms of the outputs of the gates 23u, 23v, 23w, and are connected to the gates of the low-side MOS transistors 30du, 30dv, 30dw, respectively. When the drive circuits 24u, 24v, and 24w receive the drive signals from the drive circuits 22u, 22v, and 22w, the drive circuits 24u, 24v, and 24w output the drive signals to the gates of the low-side MOS transistors 30du, 30dv, and 30dw.

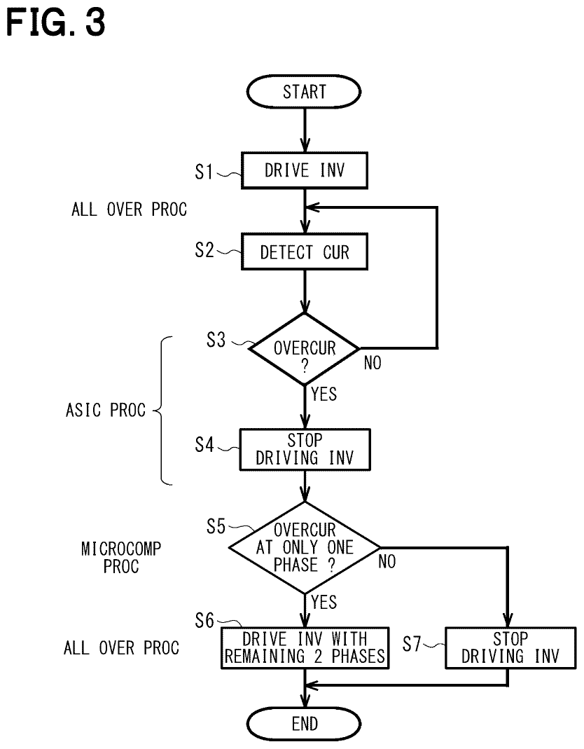

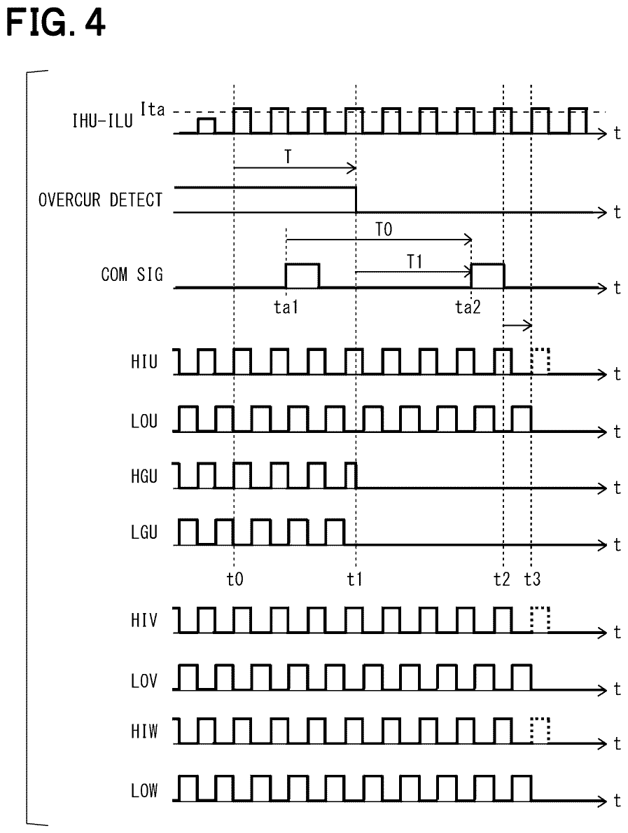

Next, the process for determining an anomaly due to an overcurrent will be described with reference to FIGS. 3 and 4. Normally, when driving the motor 55, the microcomputer 10 outputs a drive signal to the ASIC 20 using the control logics 11u, 11v, and 11w. The ASIC 20 drives the inverter 30 in response to the input drive signal in step S1 of FIG. 3, and drives the motor 55 to rotate. While the motor 55 is driven to rotate, the current amplifiers 25u, 25v, and 25w of the ASIC 20 detect the voltages between the terminals of the resistors Ru, Rv, and Rw, thereby detecting the current of the inverter 30 in step S2.

### <Notification of Overcurrent Anomaly Via Communication>

FIG. 4 shows the current detection result of the inverter 30 for one phase (for example, the U phase) and the communication timing between the microcomputer 10 and the ASIC 20. In the following example, the determination of an overcurrent anomaly by the overcurrent detection unit 26u for the U phase will be described, and the determination of an overcurrent anomaly is similarly performed for the other phases.

The communication unit 29 executes a communication process with the communication unit 19 at a predetermined period TO, and periodically notifies the communication unit 29 of the presence or absence of an anomaly. See the communication signals at timings ta1 and ta2 in FIG. 4. The overcurrent detection unit 26u detects whether the current of the inverter 30 reaches the first anomaly determination threshold Ita when some anomaly occurs, and determines whether an overcurrent anomaly occurs.

As shown in FIG. 4, the overcurrent detection unit 26u detects the current of the inverter 30 in a pulse form. Generally, unless some anomaly occurs, the amplitude of the detected current of the inverter 30 is less than the first anomaly determination threshold Ita. In this case, the overcurrent detection unit 26u continues to clear the count related to the overcurrent anomaly.

For example, a case will be considered in which an anomaly occurs due to some influence and the amplitude of the detected current of the inverter 30 reaches the first anomaly determination threshold Ita at timing t0 in FIG. 4. In this case, the overcurrent detection unit 26u counts the number of times the amplitude reaches the first anomaly determination threshold Ita using a counter, and determines whether the count result reaches a predetermined number of times.

The overcurrent detection unit 26u determines that an overcurrent anomaly has occurred at timing t1 when the count result reaches a predetermined number of times (e.g., four times in the example of FIG. 4). If the result of periodically counting from timing t0 does not reach the first anomaly determination threshold Ita even once, the overcurrent detection unit 26u clears the count result of the counter and repeats the count from the beginning. This is to prevent erroneous detection due to the influence of current noise as much as possible.

Similar overcurrent detection processing is performed for the V phase and the W phase, and, if, for example, the overcurrent detection unit 26u for the U phase inverter determines that there is an overcurrent anomaly, the overcurrent detection unit 26u transmits the fact that there is an overcurrent anomaly to the communication unit 29. If the overcurrent detection unit 26u determines that an overcurrent anomaly occurs at timing t1, the communication unit 29 can notify the microcontroller 10 of the existence of an overcurrent anomaly by communicating with the communication unit 19 at the next communication timing ta2, which is the time of periodic communication. In this case, the ASIC 20 notifies the microcomputer 10 of the occurrence of an overcurrent anomaly with a delay of the period T1 from the timing t1.

Thereafter, when the microcomputer 10 receives a communication signal from the communication unit 19 at timing t2 indicating that an overcurrent anomaly has occurred, the microcomputer 10 notifies the control logics 11u, 11v, and 11v of all phases of the content of the communication signal. The control logic 11u stops outputting the drive signal from timing t3 onwards after receiving the notification. See the waveforms at terminals HIU and LOU in FIG. 4. Similarly, the control logics 11v, 11v also stop outputting the drive signals from timing t3 onwards after receiving the notification. See the waveforms at terminals HIV, HIW, LOV, and LOW in FIG. 4.

### <Processing of an Independent Overcurrent Anomaly by the ASIC 20>

Usually, by executing the communication between the microcomputer 10 and the ASIC 20 as described above, the determination of the overcurrent anomaly is executed, and the microcomputer 10 provides the main means for stopping the output of the drive signal. In addition, in this embodiment, the ASIC 20 independently stops outputting the drive signal.

In FIG. 3, the microcomputer 10 and the ASIC 20 drive the inverter 30 in step S1, while detecting the current of the motor 55 in step S2, and the overcurrent detection units 26u, 26v, and 26w determine an anomaly of an overcurrent in step S3.

For example, when the overcurrent detection unit 26u determines in step S3 that there is an overcurrent anomaly, regardless of a command from the microcontroller 10, the gates 21u, 21v of the ASIC 20 cut off the drive signal received from the control logic 11u, thereby stopping the driving by the drive circuits 22u, 24u.

That is, in FIG. 4, at timing t1 when the overcurrent detection unit 26u determines that an overcurrent anomaly has occurred, the output of the drive signal can be immediately cut off and the drive can be stopped. See the waveforms at terminals HGU and LGU in FIG. 4. As a result, the driving of the inverter 30 can be stopped (at S4 in FIG. 3). This makes it possible to minimize the time from when an anomaly is detected until the driving of the U-phase high-side MOS transistor 30uu and U-phase low-side MOS transistor 30du is stopped.

Thereafter, as described above, the ASIC 20 notifies the microcomputer 10 of the determination result that there is an overcurrent anomaly, and the control logics 11u, 11v, and 11w of the microcomputer 10 stop outputting the original drive signals. At this time, if the communication unit 19 receives a notification that an anomaly has occurred in any one of the U-, V- and W-phases, the control logics 11u, 11v, and 11w of all the phases stop outputting the drive signals. As a result, the drive of the inverter 30 can be stopped by the dual system monitoring function, and robustness can be improved.

On the other hand, the overcurrent detection units 26u, 26v, and 26w of the ASIC 20 in the U-, V- and W-phases each individually count the number of times the amplitude of the detected current reaches the first anomaly determination threshold Ita. When the count result of each of the overcurrent detection units 26u, 26v, and 26w reaches a predetermined number of times, the overcurrent detection unit 26u, 26v, and 26w notify the communication unit 29 that an overcurrent anomaly has been determined. The communication unit 29 notifies the microcomputer 10 via the communication unit 9. Therefore, the microcomputer 10 can receive information via the communication unit 29 as to which of the U-, V- and W-phases an overcurrent anomaly has occurred.

When the microcomputer 10 receives the anomaly detection through the communication unit 19, the factor determination unit 11a determines the factor of the anomaly in step S5. The microcomputer 10 can determine, from the anomaly detection received from the communication unit 19, in which of the U-, V- and W-phases an anomaly has occurred.

In a case where the microcontroller 10 determines that there is an overcurrent in only one of the U-, V- and W-phases, for example the U phase when the factor determination unit 11a determines the factor of the anomaly, the microcontroller 10 stops only the phase in which the anomaly was detected and continues driving with only the remaining two phases in step S6 of FIG. 3. If only one phase is short-circuited when the microcomputer 10 drives the three-phase inverter 30, the connection point of the motor 55 of the short-circuited phase can be connected to the midpoint of the power source voltage VB, and the motor 55 can be controlled by the remaining two phases. This allows the motor 55 to continue to be driven while stopping the drive of only the phase in which an anomaly has occurred.

On the other hand, when the microcomputer 10 determines that an anomaly due to overcurrent exists in two or more of the U-, V- and W-phases, the control logics 11u, 11v, and 11w stop outputting all of the drive signals. As a result, the inverter 30 can be stopped in step S7 of FIG. 3, and the driving of the motor 55 can be stopped even if an anomaly occurs. The microcomputer 10 may disable the energization from the inverter 30 to the motor 55 by controlling the gates of the relay transistors 42u, 42v, and 42w to be off.

### Comparison Example

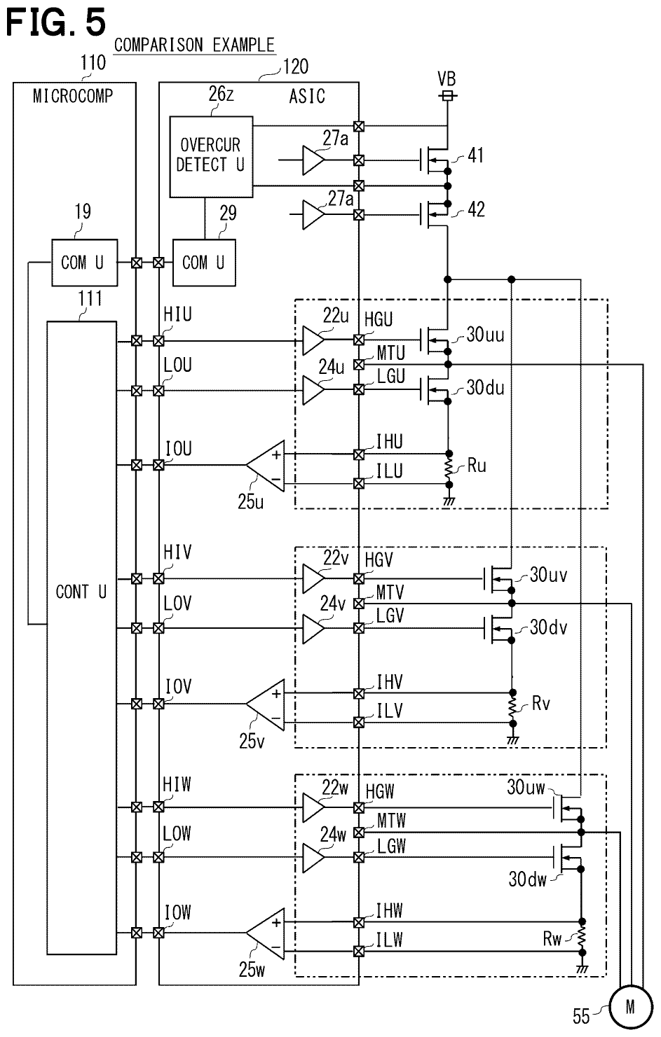

The difficulties, technical significance, and effects of this embodiment will be described below. FIG. 5 shows the configurations of the microcomputer 110 and the ASIC 120 of the comparison example. As shown in the ASIC 120 of FIG. 5, for example, a system in which an overcurrent detection unit 26z mounted on the ASIC 120 detects the drain-source voltage of the backflow prevention transistor 41 to determine whether an overcurrent anomaly has occurred will be described. When the overcurrent detection unit 26z determines that an anomaly of an overcurrent exists, the communication unit 29 of the ASIC 120 notifies the communication unit 19 of the microcomputer 110, and the control unit 111 of the microcomputer 110 stops outputting the drive signal. When an overcurrent anomaly is detected in this manner, communication processing between the communication units 29 and 19 may take a long time.

### Summary of the Present Embodiment

According to this embodiment, when the U-phase overcurrent detection unit 26u determines that there is an anomaly, regardless of a command from the microcomputer 10, the gates 21u, 23u of the ASIC 20 can stop the driving of the drive circuits 22u, 24u. Therefore, if the overcurrent detection units 26u, 26v, and 26w determine that an anomaly of an overcurrent exists, the driving can be stopped immediately without a command from the microcomputer 10. This makes it possible to minimize the time until the driving of the U-phase high-side MOS transistor 30uu and low-side MOS transistor 30du is stopped. The same effect can be obtained for the V phase and the W phase.

According to this embodiment, by maximizing the use of the functions of the overcurrent detection units 26u, 26v, and 26w mounted on the ASIC 20, it is possible to minimize the need for additional functions while minimizing the time from the detection of an anomaly to the stopping of the inverter 30 of the phase in which the anomaly has occurred. As a result, it is possible to reduce the possibility of the inverter driving element being damaged by the high-side MOS transistors 30uu, 30uv, 30uw or the low-side MOS transistors 30du, 30dv, 30dw. Alternatively, the element tolerance of the inverter driving element can be lowered, and the size of the element can be reduced.

### Second Embodiment

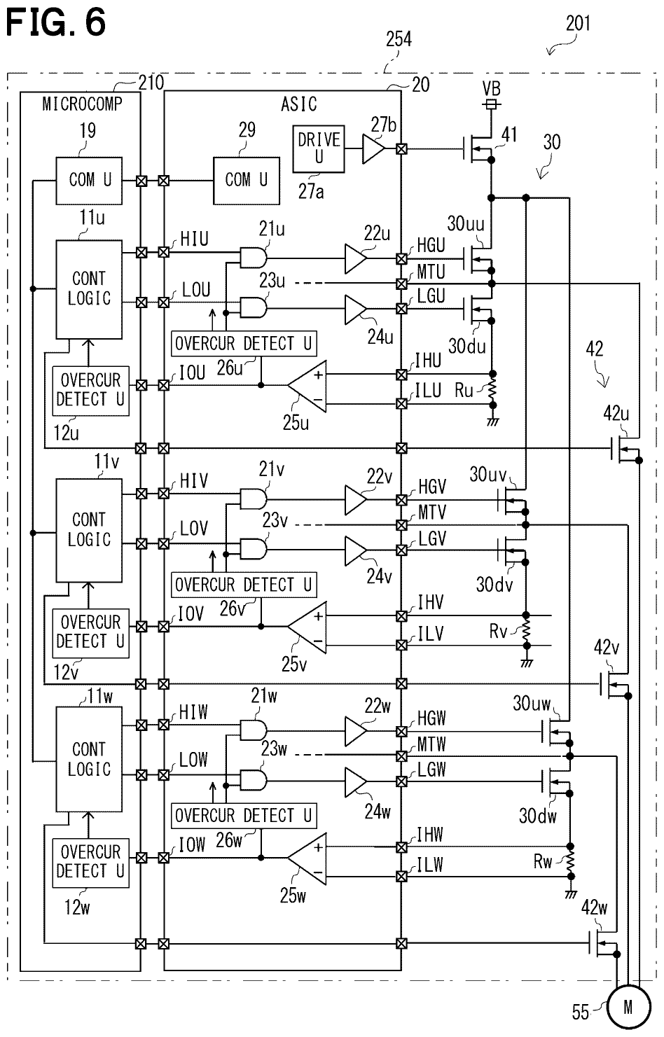

The following describes a second embodiment with reference to FIGS. 6 to 9. As shown in FIG. 6, a control system 201 of this embodiment includes a motor drive device 254 instead of the motor drive device 54. The motor drive device 254 includes a microcomputer 210, which includes a communication unit 19, control logics 11u, 11v, and 11w, and also overcurrent detection units 12u, 12v, and 12w.

The microcomputer 210 includes overcurrent detection units 12u, 12v, and 12w for each of the U-, V-, and W-phases, which determine whether an overcurrent anomaly occurs. The overcurrent detection units 12u, 12v, and 12w are configured as individual anomaly determination units. The overcurrent detection unit 12u independently determines whether an anomaly in an overcurrent flows through the high-side MOS transistor 30uu and the low-side MOS transistor 30du, regardless of a notification operation from the communication unit 29 of the ASIC 20.

The overcurrent detection unit 12v independently determines whether an anomaly in an overcurrent flows through the high-side MOS transistor 30uv and the low-side MOS transistor 30dv, regardless of a notification operation from the communication unit 29 of the ASIC 20. The overcurrent detection unit 12w independently determines whether an anomaly in an overcurrent flows through the high-side MOS transistor 30uw and the low-side MOS transistor 30dw, regardless of a notification operation from the communication unit 29 of the ASIC 20.

The overcurrent detection units 12u, 12v, and 12w determine an overcurrent anomaly by comparing the detected currents by the current amplifiers 25u, 25v, and 25w, which are transmitted from the ASIC 20 via the terminals IOU, IOV, and IOW, respectively, with a predetermined second anomaly determination threshold Itm.

Here, a feature will be described in which the second anomaly determination threshold values Itm for each of the U-, V- and W-phases are set to the same value, but the present embodiment is not limited to this feature. The second anomaly determination threshold values Itm for each of the U-, V-, and W-phases may be set to different values.

As described in the first embodiment, the overcurrent detection units 26u, 26v, and 26w of the ASIC 20 determine an overcurrent anomaly by comparing the currents detected by the current amplifiers 25u, 25v, and 25w with a predetermined first anomaly determination threshold Ita, respectively. In this embodiment, the first anomaly determination threshold Ita of the overcurrent detection units 26u, 26v, and 26w of the ASIC 20 is set to be lower than the second anomaly determination threshold Itm of the overcurrent detection units 12u, 12v, and 12w of the microcomputer 210. The other configurations are similar to those of the first embodiment, and therefore description of the other configurations will be omitted.

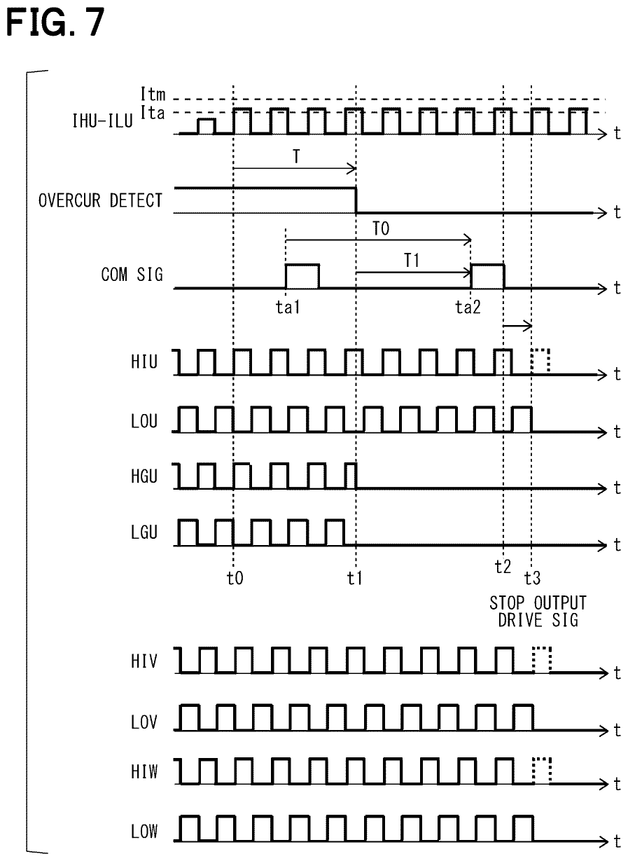

Variations in the operation when determining an anomaly due to an overcurrent will be described with reference to FIGS. 7 to 9. FIG. 7 shows waveforms of various parts when an anomaly occurs and the amplitude of the detected current of the motor 55 changes to be equal to or greater than the first anomaly determination threshold Ita and less than the second anomaly determination threshold Itm. In this case, the processing content is the same as that shown in FIG. 4 used in the explanation of the first embodiment.

After receiving the notification from the communication unit 19, the control logics 11u, 11v, and 11w stop outputting the drive signals from timing t3 onwards. See the waveforms at terminals HIU, HIV, HIW, LOU, LOV, and LOW in FIG. 7.

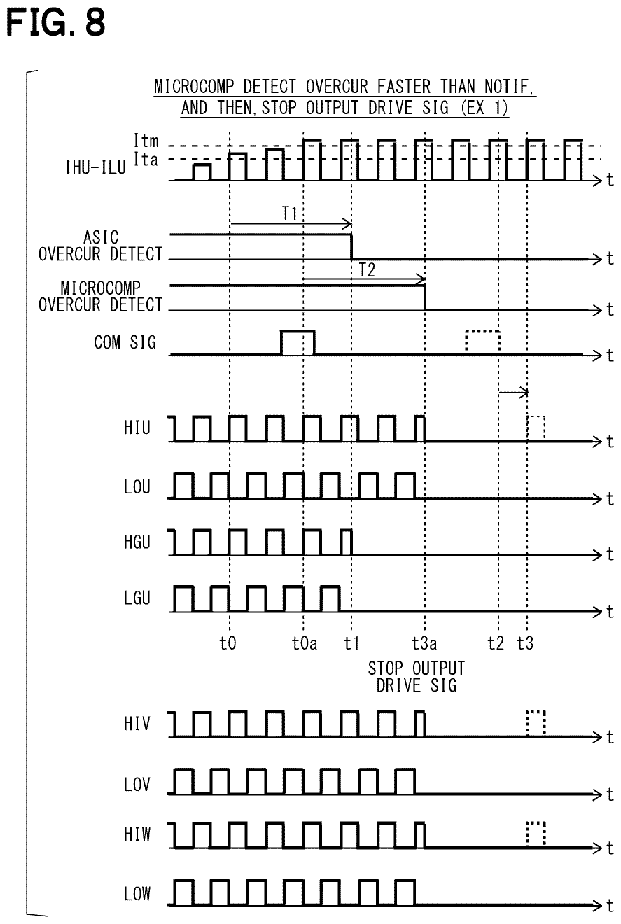

In the event of an anomaly, the amplitude of the detected current of the inverter 30 may vary significantly. FIG. 8 shows the signal waveforms of each part in the case where, around the initial timing t0 when the anomaly occurs, the amplitude of the detected current of the inverter 30 is equal to or greater than the first anomaly determination threshold Ita and less than the second anomaly determination threshold Itm, but the amplitude of the detected current then gradually changes significantly.

The microcomputer 210 counts the number of times that the current amplitude of the inverter 30 reaches the second anomaly determination threshold Itm according to the overcurrent detection unit 12u. In the example of FIG. 8, the overcurrent detection unit 12u continues counting from time t0a, and determines that an overcurrent anomaly has occurred around time t3a when the count result reaches a predetermined number of times (e.g., four times in the example of FIG. 8).

The control logic 11u stops the output of the drive signal at timing t3a when the overcurrent detection unit 12u determines that an anomaly in an overcurrent exists. See the waveforms at terminals HIU and LOU in FIG. 8. The control logic 11u notifies the control logics 11v and 11w that there is an anomaly of an overcurrent, so that the control logics 11v and 11w can stop outputting the drive signals at timing t3a. See the waveforms at terminals HIV, HIW, LOV, and LOW in FIG. 8.

This allows the microcomputer 210 to stop outputting the drive signal earlier than the output stop timing t3 of the drive signal received from the ASIC 20 by communication. Moreover, the ASIC 20 can stop outputting the drive signal at timing t1, which is earlier than timing t3a at which the microcomputer 210 stops outputting the drive signal. See the waveforms at terminals HGU and LGU in FIG. 8.

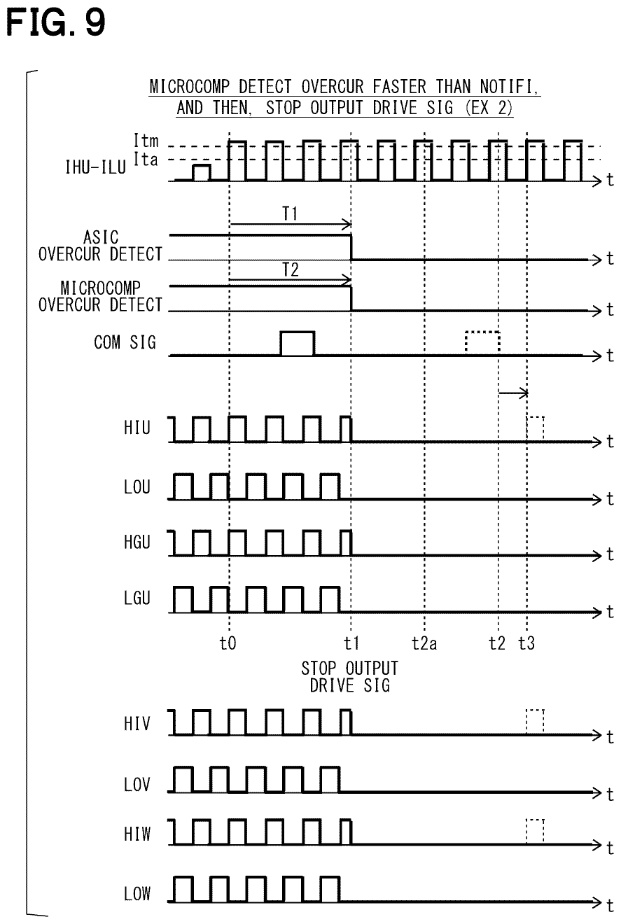

FIG. 9 shows waveforms of various parts when the amplitude of the detected current of the motor 55 changes significantly from approximately timing t0 when the anomaly initially occurs so that the amplitude reaches the second anomaly determination threshold value Itm.

The microcomputer 210 counts the number of times that the current amplitude of the motor 55 reaches the second anomaly determination threshold Itm according to the overcurrent detection unit 12u. In the example of FIG. 9, the overcurrent detection unit 12u continues counting from time t0a, and determines that an overcurrent anomaly has occurred around time t1 when the count result reaches a predetermined number of times (e.g., four times in the example of FIG. 8).

The control logic 11u stops the output of the drive signal at timing t1 when the overcurrent detection unit 12u determines that an anomaly in an overcurrent exists. See the waveforms at terminals HIU and LOU in FIG. 9. The control logic 11u notifies the control logics 11v and 11w that there is an anomaly of an overcurrent, so that the control logics 11v and 11w can stop outputting the drive signals at timing t1. See the waveforms at terminals HIV, HIW, LOV, and LOW in FIG. 9.

This allows the microcomputer 210 to stop outputting the drive signal earlier than the output stop timing t3 of the drive signal received from the ASIC 20 by communication. Moreover, the ASIC 20 can stop outputting the drive signal at the same timing t1 as an equivalent timing when the microcomputer 210 stops outputting the drive signal. See the waveforms at terminals HGU and LGU in FIG. 9.

As described above, according to this embodiment, the first anomaly determination threshold Ita of the overcurrent detection units 26u, 26v, and 26w of the ASIC 20 is set to be lower than the second anomaly determination threshold Itm of the overcurrent detection units 12u, 12v, and 12w of the microcontroller 210. Therefore, even if the amplitude of the current of the motor 55 fluctuates greatly, the microcontroller 210 can stop outputting the drive signal at timing t3a or t1 that is earlier than or equal to timing t3 of stopping the output of the drive signal received via communication from the ASIC 20.

### Third Embodiment

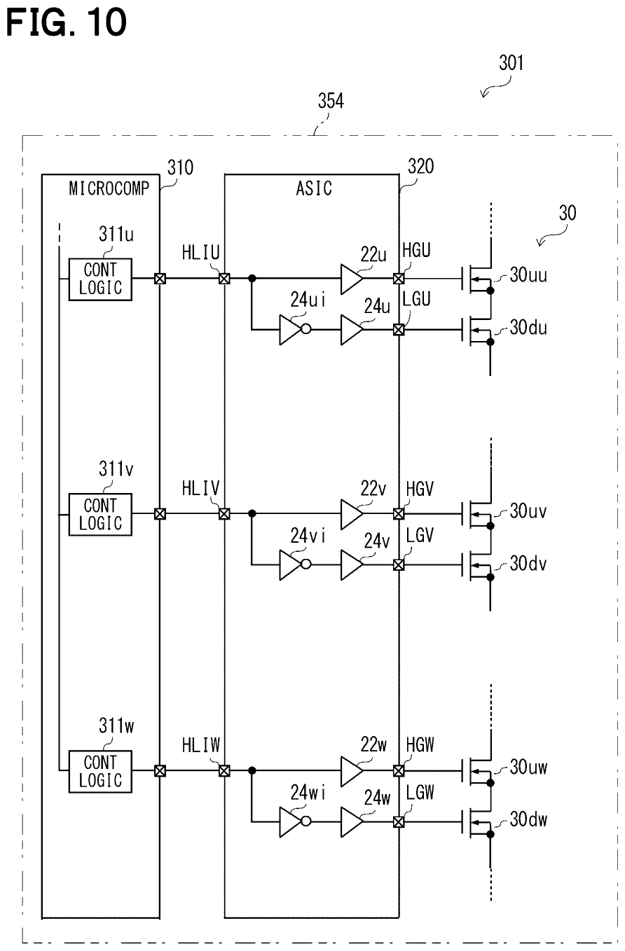

The following describes a third embodiment with reference to FIG. 10. As shown in FIG. 10, a control system 301 of this embodiment includes a motor drive device 354 instead of the motor drive device 54. The motor driving device 354 includes a microcomputer 310 and an ASIC 320. An ASIC 320 provides a semiconductor apparatus, or equivalent to the semiconductor device main body. The microcomputer 310 includes control logics 311u, 311v, and 311w.

The control logics 311u, 311v, and 311w of the microcomputer 310 combine the high-side drive signals and the low-side drive signals into a single signal and output the combined signal. The ASIC 320 includes terminals HLIU, HLIV, and HLIW for inputting the drive signal collectively output from the microcomputer 310. The ASIC 320 includes drive circuits 22u, 22v, 22w, 24u, 24v, and 24w, and also includes NOT gates 24ui, 24vi, and 24wi in front of the drive circuits 24u, 24v, and 24w.

The input nodes of the NOT gates 24ui, 24vi, and 24wi and the input nodes of the drive circuits 22u, 22v, and 22w are commonly connected. The common connection point is connected to terminals HLIU, HLIV, and HLIW, respectively.

When the drive signals output from the control logics 311u, 311v, and 311w are input to terminals HLIU, HLIV, and HLIW, respectively, the drive signals are converted into complementary drive signals by the NOT gates 24ui, 24vi, and 24wi.

The drive circuits 22u, 22v, 22w and the drive circuits 24u, 24v, 24w apply complementary drive signals between the gates and sources of the high-side MOS transistors 30uu, 30uv, 30uw and between the gates and sources of the low-side MOS transistors 30du, 30dv, 30dw, respectively. Even when such a circuit configuration of the ASIC 320 is applied, the inverter 30 can be similarly controlled and driven. The other configurations are similar to those of the first embodiment, and therefore illustrations and descriptions of the other configurations are omitted.

According to this embodiment, the ASIC 320 receives a drive signal input from the microcomputer 310 as a command, and generates drive signals to drive the high-side MOS transistors 30uu, 30uv, 30uw and the low-side MOS transistors 30du, 30dv, 30dw based on the command of the drive signal. At this time, the ASIC 320 separates the single drive signal output by the microcomputer 310 for each of the U-, V- and W-phases into a high-side drive signal and a low-side drive signal. Even in this configuration, the inverter 30 and the motor 55 can be driven in the same manner as in the above-described embodiments.

### Fourth Embodiment

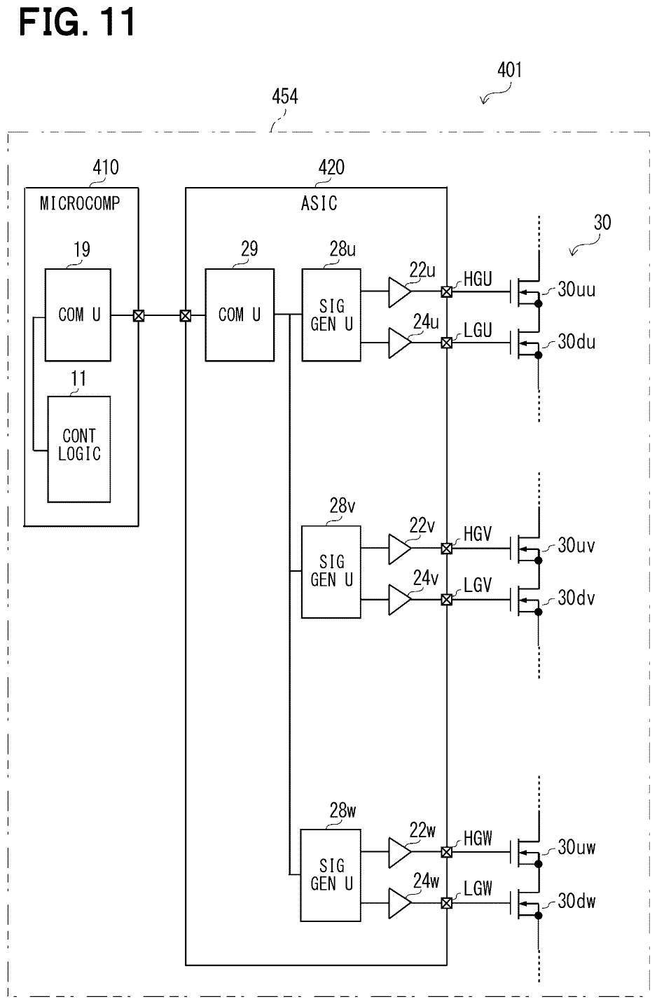

A fourth embodiment will be described with reference to FIG. 11. In the first to third embodiments described above, the drive signals of the high-side MOS transistors 30uu, 30uv, and 30uw and the low-side MOS transistors 30du, 30dv, and 30dw are received, and the drive signals are waveform-shaped and output. However, the present embodiments are not limited to this feature. It may be configured as a control system 401 in FIG. 11.

As shown in FIG. 11, a control system 401 of this embodiment includes a motor drive device 454 instead of the motor drive device 54. The motor driving device 454 includes a microcomputer 410 and an ASIC 420. An ASIC 420 provides a semiconductor apparatus, or equivalent to the semiconductor device main body.

The microcomputer 410 includes a control logic 11 and a communication unit 19. The microcomputer 410 outputs a communication signal in a predetermined format as a command to the ASIC 420 via the communication unit 19. The ASIC 420 includes a communication unit 29, signal generation units 28u, 28v, and 28w, and drive circuits 22u, 22v, 22w, 24u, 24v, and 24w. The communication unit 19 of the microcomputer 410 and the communication unit 29 of the ASIC 420 are capable of data communication and transmit and receive communication signals.

When the signal generation units 28u, 28v, and 28w of the ASIC 420 receive a communication signal as a command from the microcomputer 410 via the communication unit 29, the signal generation units 28u, 28v, and 28w convert the communication signal into a drive signal. The signal generation units 28u, 28v, and 28w generate complementary drive signals and output the complementary drive signals to the drive circuits 22u, 22v, and 22w and the drive circuits 24u, 24v, and 24w.

The drive circuits 22u, 22v, 22w and the drive circuits 24u, 24v, 24w apply complementary drive signals between the gates and sources of the high-side MOS transistors 30uu, 30uv, 30uw and between the gates and sources of the low-side MOS transistors 30du, 30dv, 30dw, respectively. Even in this configuration, the inverter 30 and the motor 55 can be driven in the same manner as in the above-described embodiments.

### Fifth Embodiment

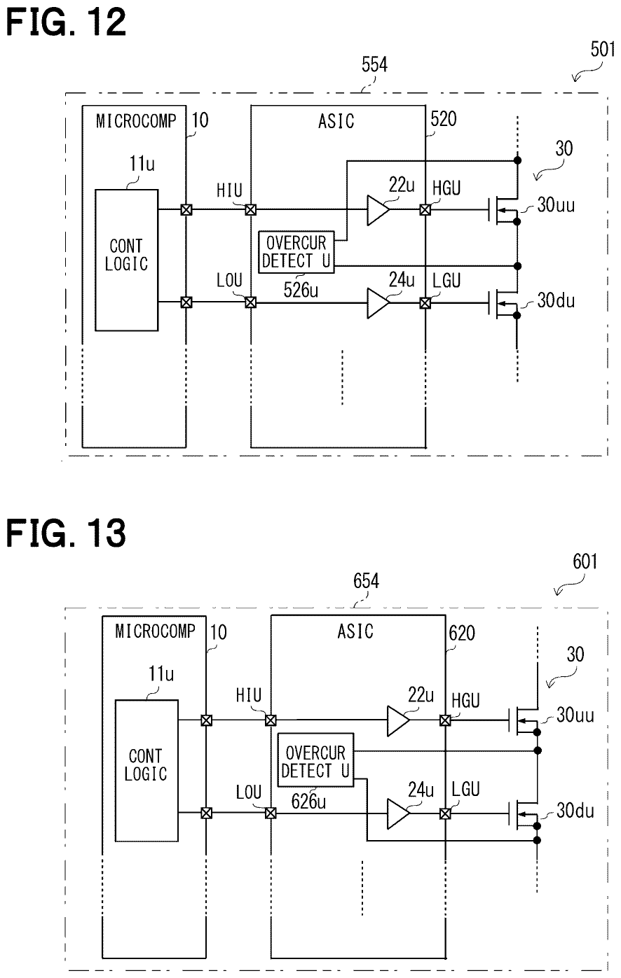

A fifth embodiment will be described with reference to FIG. 12. As shown in FIG. 12, a control system 501 of this embodiment includes a motor drive device 554 instead of the motor drive device 54. The motor driving device 554 includes a microcomputer 510 and an ASIC 520. Here, the configuration of the U phase will be described, and since the configurations of the V phase and W phase are similar to the configuration of the U phase, illustrations and descriptions thereof will be omitted. An ASIC 520 provides a semiconductor apparatus, or equivalent to the semiconductor device main body.

The ASIC 520 includes an overcurrent detection unit 526u in the U phase as an anomaly determination unit. The overcurrent detection unit 526u includes a voltage detection unit that detects the differential voltage between the drain and source of the high-side MOS transistor 30uu, and a counter that counts the number of times that the differential voltage reaches a predetermined voltage threshold, and determines an anomaly based on whether the counted number reaches a predetermined number. With this configuration, the same effects as those of the above-described embodiment can be achieved.

### Sixth Embodiment

A sixth embodiment will be described with reference to FIG. 13. As shown in FIG. 13, a control system 601 of this embodiment includes a motor drive device 654 instead of the motor drive device 54. The motor driving device 654 includes a microcomputer 10 and an ASIC 620. Here, the configuration of the U phase will be described, and since the configurations of the V phase and W phase are similar to the configuration of the U phase, illustrations and descriptions thereof will be omitted. An ASIC 620 provides a semiconductor apparatus, or equivalent to the semiconductor device main body.

The motor driver 654 includes an ASIC 620. The ASIC 620 includes an overcurrent detection unit 626u in the U phase as an anomaly determination unit. The overcurrent detection unit 626u includes a voltage detection unit that detects the differential voltage between the drain and source of the low-side MOS transistor 30du, and a counter that counts the number of times that the differential voltage reaches a predetermined voltage threshold, and determines an anomaly based on whether the counted number reaches a predetermined number. With this configuration, the same effects as those of the above-described embodiment can be achieved.

### Other Embodiments

The present disclosure is not limited to the embodiment described above, and, for example, may be modified or expanded, which will be described.

In the above embodiment, the pinion assist type electric power steering system 50 has been described, but the present embodiments are not limited to this feature. For example, the present embodiments may be applied to a rack-assist type electric power steering system, or a column-assist type electric power steering system. Although the present embodiments are applied to a three-phase inverter 30, the present embodiments can be applied to an inverter having a predetermined number of phases exceeding three phases.

The microcomputer 10 and the method thereof of the present disclosure may be implemented by a dedicated computer provided by configuring a processor and a memory programmed to execute one or more functions embodied by a computer program. Alternatively, the microcomputer 10 and the method thereof described in the present disclosure may be implemented by a dedicated computer provided by configuring a processor with one or more dedicated hardware logic circuits.

In the drawings, 1, 201, 301, 401, 501, and 601 indicate control systems, 10, 210, and 310 indicate microcomputers, 11a indicate a factor determination unit, 12u, 12v, and 12w indicate overcurrent detection units (i.e., single anomaly determination units), 20, 320, 420, 520, and 620 indicate ASICs (semiconductor apparatus or semiconductor device main body), 21u, 21v, 21w, 23u, 23v, and 23w indicate gates (i.e., stopping units), 22u, 22v, 22w, 24u, 24v, and 24w indicate drive circuits, 26u, 26v, and 26w indicate overcurrent detection units (i.e., anomaly determination units), 29 indicates a communication unit (i.e., notification unit), and 30uu, 30du, 30uv, 30dv, 30uw, and 30dw indicate MOS transistors (i.e., inverter driving elements).

In addition to the contents described below, the present disclosure also includes the following contents.

Feature 1: A semiconductor apparatus constitutes a control system for driving an inverter drive element (30uu, 30du, 30uv, 30dv, 30uw, 30dw) in accordance with a command received by the semiconductor device main body from the microcomputer. The control system includes: a microcomputer (10, 210, 310); and a semiconductor device main body (20, 320, 420, 520, 620) which is different from the microcomputer. The semiconductor apparatus includes: a drive circuit (22u, 22v, 22w, 24u, 24v, 24w) that drives the inverter drive element in accordance with the command received from the microcomputer; an anomaly determination unit (26u, 26v, 26w) that determines an anomaly of an overcurrent flowing through the inverter drive element; and a stop unit (21u, 21v, 21w, 23u, 23v, 23w) that stops driving the inverter drive element by the drive circuit regardless of the command from the microcomputer when the anomaly determination unit determines that the anomaly of the overcurrent occurs.

Feature 2: The semiconductor apparatus according to the feature 1, further includes: a notification unit (29) that notifies the microcomputer of detection of the anomaly when the anomaly determination unit determines that the anomaly of the overcurrent occurs.

Feature 3: In the semiconductor apparatus according to the feature 1 or 2, the microcomputer includes an independent anomaly determination unit (12u, 12v, 12w) that determines the anomaly of the overcurrent flowing through the inverter drive element independently of a notification operation from the notification unit of the semiconductor device main body (20). The anomaly determination unit of the semiconductor device main body determines the anomaly of the overcurrent by comparing a predetermined first anomaly determination threshold with a current flowing through the inverter drive element. The independent anomaly determination unit of the microcomputer determines the anomaly of the overcurrent by comparing a predetermined second anomaly determination threshold with a current flowing through the inverter drive element. The first anomaly determination threshold of the semiconductor device main body is set to be lower than the second anomaly determination threshold of the microcomputer.

Feature 4: In the semiconductor apparatus according to any one of the features 1 to 3, the semiconductor device main body receives a drive signal or a communication signal from the microcomputer as the command, and generates a drive signal for driving the inverter drive element based on the command.

Feature 5: In the semiconductor apparatus according to any one of the features 1 to 4, the inverter drive element is an element that constitutes an inverter (30) by bridge-connecting a high-side MOS transistor (30uu, 30uv, 30uw) and a low-side MOS transistor (30du, 30dv, 30dw). The anomaly determination unit detects a differential voltage between terminals of a shunt resistor (R) connected in series to the inverter drive element, between a drain and a source of the high-side MOS transistor, or between a drain and a source of the low-side MOS transistor to determine the anomaly.

Feature 6: A control system includes: a microcomputer (10, 210, 310); and a semiconductor device main body (20, 320, 420, 520, 620) which is different from the microcomputer. The control system further includes: a semiconductor apparatus constituting the control system for driving an inverter drive element (30uu, 30du, 30uv, 30dv, 30uw, 30dw) in accordance with a command received by the semiconductor device main body from the microcomputer. The semiconductor apparatus includes: a drive circuit (22u, 22v, 22w, 24u, 24v, 24w) that drives the inverter drive element in accordance with the command received from the microcomputer; an anomaly determination unit (26u, 26v, 26w) that determines an anomaly of an overcurrent flowing through the inverter drive element; a stop unit (21u, 21v, 21w, 23u, 23v, 23w) that stops driving the inverter drive element by the drive circuit regardless of the command from the microcomputer when the anomaly determination unit determines that the anomaly of the overcurrent occurs; a notification unit (29) that notifies the microcomputer of detection of the anomaly when the anomaly determination unit determines that the anomaly of the overcurrent occurs. The microcomputer transmits a command to the semiconductor device main body to stop a drive circuit when receiving a detection of the anomaly from the notification unit.

Feature 7: In the control system according to the feature 6, the inverter drive element is configured by being bridge-connected to drive a motor having three or more predetermined phases. The microcomputer includes a factor determination unit (11a) that determines a factor of the anomaly when receiving a detection of the anomaly from the notification unit. When the factor determination unit determines the factor of the anomaly and determines that the overcurrent flows in only one of the three or more predetermined phases, the only one of the three or more predetermined phases in which the anomaly is detected is stopped, and remaining phases continue to be driven with respect to the inverter drive element which is configured by being bridge-connected.

Feature 8: The semiconductor apparatus according to any one of the features 1 to 5 is applied to an electric power steering system.

Feature 9: The control system according to any one of the features 6 to 7 is applied to an electric power steering system.

Although the present disclosure has been made in accordance with the embodiments, it is understood that the present disclosure is not limited to such embodiments and structures. The present disclosure includes various modifications or deformations within an equivalent range. In addition, while the various combinations and configurations, which are preferred, other combinations and configurations, including more, less or only a single element, are also within the spirit and scope of the present disclosure.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A semiconductor apparatus constituting a control system for driving an inverter drive element in accordance with a command received by a semiconductor device main body from a microcomputer, the control system including a microcomputer; and a semiconductor device main body which is different from the microcomputer, the semiconductor apparatus comprising:
a drive circuit that drives the inverter drive element in accordance with the command received from the microcomputer;
an anomaly determination unit that determines an anomaly of an overcurrent flowing through the inverter drive element; and
a stop unit that stops driving the inverter drive element by the drive circuit regardless of the command from the microcomputer when the anomaly determination unit determines that the anomaly of the overcurrent occurs, wherein:
the microcomputer includes an independent anomaly determination unit that determines the anomaly of the overcurrent flowing through the inverter drive element independently of a notification operation from a notification unit of the semiconductor device main body;
the microcomputer outputs the command for stopping the drive circuit to the semiconductor device main body when the independent anomaly determination unit determines the anomaly of the overcurrent;
the anomaly determination unit of the semiconductor device main body determines the anomaly of the overcurrent by comparing a predetermined first anomaly determination threshold with a current flowing through the inverter drive element;
the independent anomaly determination unit of the microcomputer determines the anomaly of the overcurrent by comparing a predetermined second anomaly determination threshold with a current flowing through the inverter drive element; and
the first anomaly determination threshold of the semiconductor device main body is set to be lower than the second anomaly determination threshold of the microcomputer.

2. The semiconductor apparatus according to claim 1, further comprising:
a notification unit that notifies the microcomputer of detection of the anomaly when the anomaly determination unit determines that the anomaly of the overcurrent occurs.

3. The semiconductor apparatus according to claim 1, wherein:
the semiconductor device main body receives a drive signal or a communication signal from the microcomputer as the command, and generates another drive signal for driving the inverter drive element based on the command.

4. The semiconductor apparatus according to claim 1, wherein:
the inverter drive element is an element that constitutes an inverter by bridge-connecting a high-side MOS transistor and a low-side MOS transistor; and
the anomaly determination unit detects a differential voltage between terminals of a shunt resistor connected in series to the inverter drive element, between a drain and a source of the high-side MOS transistor, or between a drain and a source of the low-side MOS transistor to determine the anomaly.

5. The semiconductor apparatus according to claim 1, wherein:
the semiconductor apparatus is applied to an electric power steering system.

6. A control system comprising:
a microcomputer; and
a semiconductor device main body which is different from the microcomputer,
the control system further comprising:
a semiconductor apparatus that constitutes the control system for driving an inverter drive element in accordance with a command received by the semiconductor device main body from the microcomputer, wherein:
the semiconductor apparatus includes: a drive circuit that drives the inverter drive element in accordance with the command received from the microcomputer; an anomaly determination unit that determines an anomaly of an overcurrent flowing through the inverter drive element; a stop unit that stops driving the inverter drive element by the drive circuit regardless of the command from the microcomputer when the anomaly determination unit determines that the anomaly of the overcurrent occurs; and a notification unit that notifies the microcomputer of detection of the anomaly when the anomaly determination unit determines that the anomaly of the overcurrent occurs;
the microcomputer transmits the command to the semiconductor device main body to stop the drive circuit when receiving a detection of the anomaly from the notification unit;
the inverter drive element is configured by being bridge-connected to drive a motor having three or more predetermined phases;
the microcomputer includes a factor determination unit that determines a factor of the anomaly when receiving a detection of the anomaly in one or more of the three or more predetermined phases from the notification unit; and
when the factor determination unit determines the factor of the anomaly and determines that the overcurrent flows in only one of the three or more predetermined phases, the only one of the three or more predetermined phases in which the anomaly is detected is stopped, and remaining phases continue to be driven with respect to the inverter drive element which is configured by being bridge-connected.

7. The control system according to claim 6, wherein:
the control system is applied to an electric power steering system.
